(19) United States
(12) Patent Application Publication
(10) Pub. No.: US 2017/0214829 A1
(43) Pub. Date: Jul. 27, 2017

(54) INFORMATION PROCESSING APPARATUS, IMAGE OUTPUT CONTROL METHOD, AND COMPUTER-READABLE RECORDING MEDIUM

(71) Applicant: Kei NAKABAYASHI, Kanagawa (JP)

(72) Inventor: Kei NAKABAYASHI, Kanagawa (JP)

(21) Appl. No.: 15/413,876

(22) Filed: Jan. 24, 2017

(30) Foreign Application Priority Data
Jan. 27, 2016 (JP) 2016-013485

(51) Int. Cl. H04N 1/44; H04N 1/32; H04N 1/00

(52) U.S. Cl. CPC H04N 1/444; H04N 1/00846; H04N 1/32144; H04N 2201/0094; H04N 2201/3205; H04N 2201/3236; H04N 2201/327; H04N 2201/3271; H04N 2201/0098

(57) ABSTRACT

An information processing apparatus includes a detector, a destination specifier, a request transmitter, a response receiver, and an output controller. The detector is configured to detect embedment information embedded onto image data. The destination specifier is configured to specify a destination to which a request for determination on whether to permit an output of the image data is transmitted based on the detected embedment information. The request transmitter is configured to transmit the request together with the image data to the destination. The response receiver is configured to receive a response to the request. The output controller is configured to determine whether to output the image data based on the response.

### CROSS-REFERENCE TO RELATED APPLICATION

The present application claims priority under 35 U.S.C. §119 to Japanese Patent Application No. 2016-013485, filed Jan. 27, 2016. The contents of which are incorporated herein by reference in their entirety.

### BACKGROUND OF THE INVENTION

1. Field of the Invention

The present invention relates to an information processing apparatus, an image output control method, and a computer-readable recording medium.

2. Description of the Related Art

Conventionally, a technique of using a digital watermark to control an output of image data has been known. For example, Japanese Unexamined Patent Application Publication No. 2001-184184 discloses a technique of adding, as an invisible bit map pattern to image information, information like a copy counter value and limiting the number of printing to prevent the image information from being printed unlimitedly.

However, in the conventional technique of using the digital watermark to control the output of image data, a device itself determines whether or not to output the image data and an output control based on a determination by human being is not assumed. Therefore, it is impossible to perform an output control like outputting only image data whose output is permitted by a user who is different from a user who gives an instruction for outputting the image data.

### SUMMARY OF THE INVENTION

According to one aspect of the present invention, an information processing apparatus includes a detector, a destination specifier, a request transmitter, a response receiver, and an output controller. The detector is configured to detect embedment information embedded onto image data. The destination specifier is configured to specify a destination to which a request for determination on whether to permit an output of the image data is transmitted based on the detected embedment information. The request transmitter is configured to transmit the request together with the image data to the destination. The response receiver is configured to receive a response to the request. The output controller is configured to determine whether to output the image data based on the response.

### BRIEF DESCRIPTION OF THE DRAWINGS

FIG. 1 is an explanatory view schematically illustrating an example of a usage scene of a multifunction peripheral according to an embodiment;

FIG. 2 is a block diagram of an example of a hardware configuration of the multifunction peripheral according to the embodiment;

FIG. 3 is a block diagram of an example of a software configuration of the multifunction peripheral according to the embodiment;

FIG. 4 is a block diagram of an example of a functional configuration of the multifunction peripheral according to the embodiment;

FIG. 5 illustrates an example of embedment information;

FIG. 6 illustrates an example of an address book;

FIG. 7 is a flowchart of an example of an operation procedure of the multifunction peripheral according to the embodiment;

FIG. 8 is a sequence diagram explaining an example of an operation of the multifunction peripheral when an instruction for executing scan transmission is given by an operator;

FIG. 9 is a sequence diagram explaining an example of an operation of the multifunction peripheral when an instruction for executing copy is given by an operator; and

FIG. 10 is a sequence diagram explaining an example of an operation of the multifunction peripheral that outputs image data to which a stamp image is added.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

While the embodiment to be explained below is an example in which the present invention is applied to a Multifunction Peripheral/Printer (MFP) as an example of an information processing apparatus, the application example is not limited thereto. The present invention is effectively applicable to various information processing apparatuses such as various kinds of output devices including a function of outputting image data or various kinds of controlling devices that control the output of image data by those output devices.

### Brief Overview of Embodiment

When an instruction for outputting image data is given by a user (hereinafter referred to as “operator”), a multifunction peripheral (one mode of an “information processing apparatus”) according to the embodiment requests another user (hereinafter referred to as “authorizer”) to determine whether or not to permit the output of the image data. Then, the multifunction peripheral determines whether or not to output the image data based on a response by the authorizer with respect to the determination request. In other words, when the operator gives an instruction for outputting image data that requires an authorization by the authorizer, the multifunction peripheral according to the embodiment outputs the image data only when the output of the image data is permitted by the authorizer. Here, the output of the image data includes, for example, operations such as printing in which designated image data is output by printing, copying in which image data scanned by a scanner is output by printing, a scan transmission in which image data scanned by a scanner is transmitted to an external terminal via a network, and a scan accumulation in which image data scanned by a scanner is accumulated in a hard disk and the like. The multifunction peripheral according to the embodiment receives operations, by the operator, of giving instructions for those operations each as an instruction for job execution.

The determination request on whether or not to permit the output of the image data is transmitted to a terminal device (personal computer and smart phone, for example), as a destination, used by the authorizer who is supposed to make this determination. In the embodiment, a digital watermark technique is used to specify the destination. In other words, the multifunction peripheral according to the embodiment detects embedment information embedded as a digital watermark onto image data related to the job whose execution is instructed and specifies a destination to which the determination request is transmitted with the image data based on the detected embedment information.

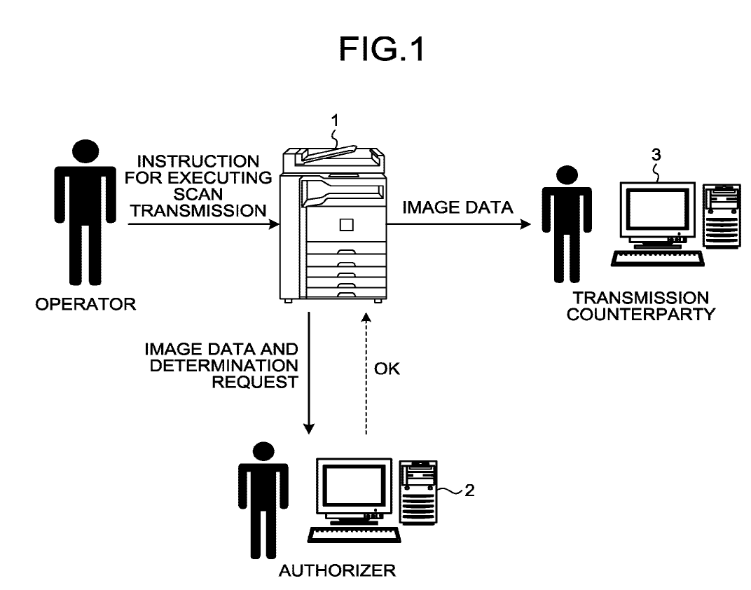

FIG. 1 is an explanatory view schematically illustrating an example of a usage scene of a multifunction peripheral 1 according to an embodiment. In the example in FIG. 1, an example of an operation of the multifunction peripheral 1 when the operator gives an instruction for executing the scan transmission is schematically illustrated.

When the operator gives the instruction for executing the scan transmission to the multifunction peripheral 1, the multifunction peripheral 1 uses a scanner engine to scan image data and detects embedment information embedded as a digital watermark onto the image data. The multifunction peripheral 1 then specifies, as a destination to which the determination request is transmitted, a mail address of a terminal device 2 of the authorizer, for example, based on the detected embedment information. The multifunction peripheral 1 then transmits the determination request on whether or not to permit the output the image data to the mail address, as a destination, specified based on the embedment information together with the image data as an output target.

The authorizer having received the determination request, for example, checks a content of the image data in accordance with a predetermined workflow and then determines whether or not to permit the output of the image data. The authorizer then transmits, as a response to the determination request, a result (YES/NO) of the determination on whether or not to permit the output of the image data from the terminal device 2 to the multifunction peripheral 1. FIG. 1 illustrates an example in which the authorizer permits the output of the image data.

On reception of the response to the determination request from the terminal device 2 of the authorizer, the multifunction peripheral 1 continues the job of the scan transmission whose execution is instructed by the operator when the response indicates permission (YES) of the output of the image data, and transmits the image data to a terminal device 3 of a designated transmission counterparty. On the other hand, when the response to the determination request indicates no permission (NO) of the output of the image data, the multifunction peripheral 1 stops the job of the scan transmission whose execution is instructed by the operator and erases the image data.

In a case where a member (operator) of a given department in a company tries to transmit a contrast document to a person in charge of another company by using the function of the scan transmission of the multifunction peripheral 1, for example, it is possible to effectively use the multifunction peripheral 1 according to the embodiment in a workflow in which an immediate manager (authorizer) checks a content of the contact document to allow a transmission of only a contract document with no problem. In this case, embedment information that allows specifying a mail address and the like of a terminal device used by the immediate manager is embedded, as a digital watermark, onto image data of the contract document created by the member in the given department. The multifunction peripheral 1 specifies the mail address and the like of the terminal device of the immediate manager based on the embedment information embedded as a digital watermark onto the image data of the contract document and transmits the determination request to the mail address as the destination together with the image data of the contract document. A concrete configuration example and operation of the multifunction peripheral 1 according to the embodiment will be explained more specifically below.

Hardware Configuration

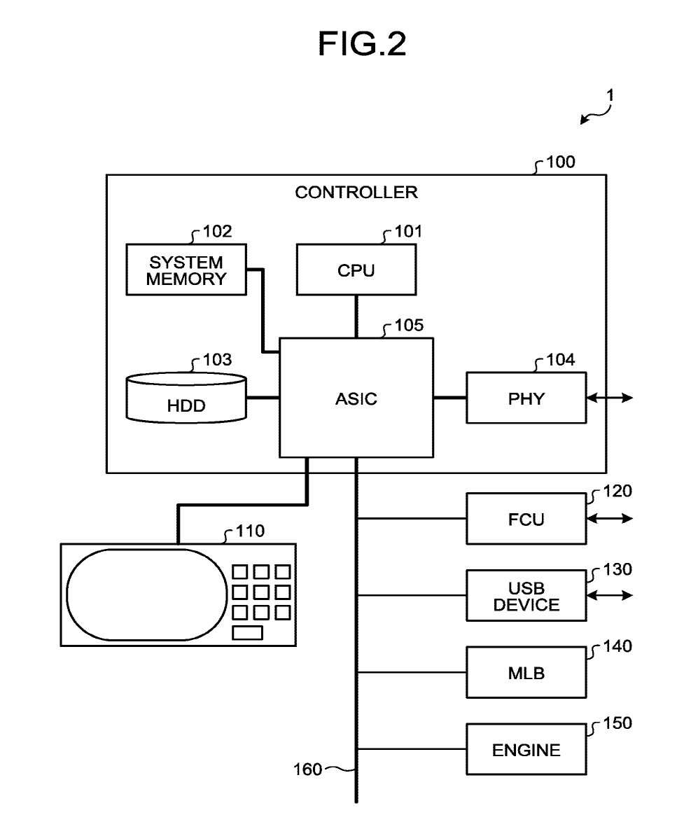

FIG. 2 is a block diagram of an example of a hardware configuration of the multifunction peripheral 1 according to the embodiment. As illustrated in FIG. 2, the multifunction peripheral 1 according to the embodiment is provided with a controller 100, an operation panel 110, a facsimile control unit (FCU) 120, a Universal Serial Bus (USB) device 130, a media link board (MLB) 140, and an engine 150, for example.

The operation panel 110 is a user interface through which the operator gives instructions for executing various kinds of jobs and performs inputs for setting and which displays information of various kinds to be presented to the operator. The FCU 120 is a control unit that controls a facsimile function of the multifunction peripheral 1. The USB device 130 is a device connected to the multifunction peripheral 1 via the USB. The MLB 140 is a conversion board that performs a format conversion on image data. The engine 150 is, for example, a scanner engine that scans an image, or a plotter engine that performs printing.

The controller 100 is a control device that controls an operation of the multifunction peripheral 1. As illustrated in FIG. 2, the controller 100 is provided with a CPU 101, a system memory 102, a hard disk drive (HDD) 103, a PHY 104, and an Application Specific Integrated Circuit (ASIC) 105. The operation panel 110 is connected to the ASIC 105 of the controller 100. The FCU 120, the USB device 130, the MLB 140, and the engine 150 are connected to the ASIC 105 of the controller 100 via a data transfer bus 160.

The control of various kinds of operations in the multifunction peripheral 1 is realized by software of various kinds to be executed by the CPU 101 of the controller 100. The CPU 101 activates and executes, as processes on an operation system (hereinafter referred to as “OS”), software of various kinds belonging to a control service layer in a software group to be explained later and software of various kinds belonging to a handler layer. Moreover, the CPU 101 activates and executes software of various kinds belonging to an application layer in the software group to be explained later to control various operations in the multifunction peripheral 1.

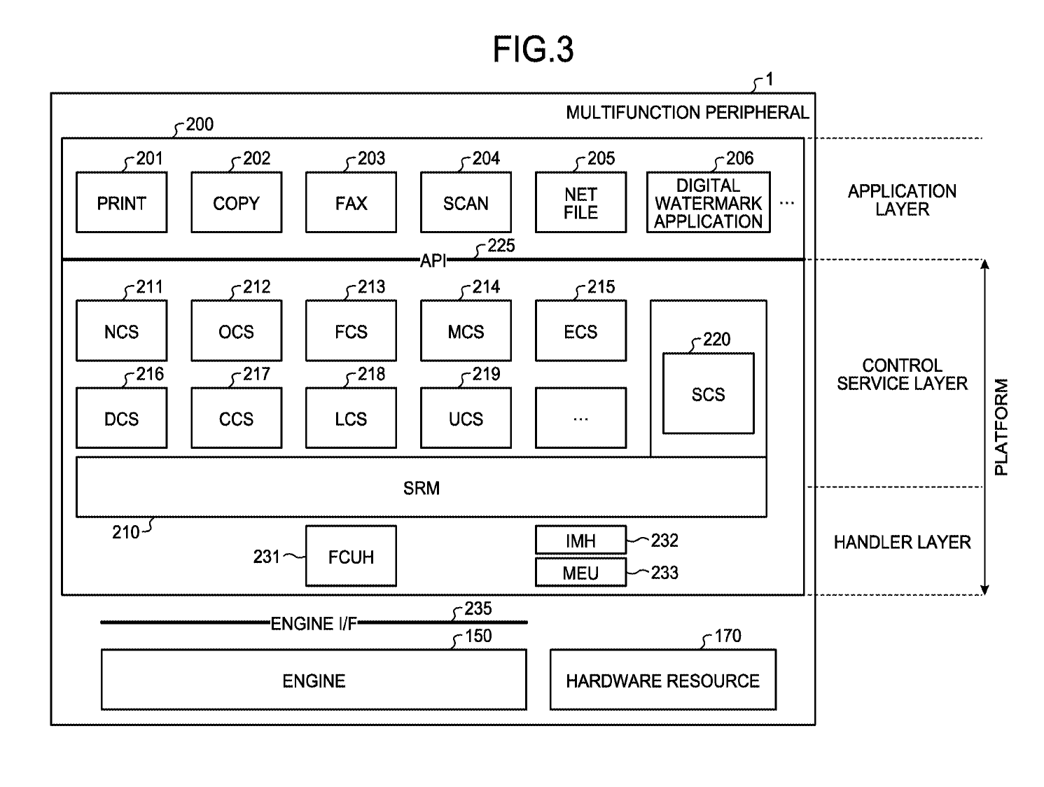

Software Configuration FIG. 3 is a block diagram of an example of a software configuration of the multifunction peripheral 1 according to the embodiment. As illustrated in FIG. 3, the multifunction peripheral 1 is provided with a software group 200 that allows realizing various kinds of operations by using the engine 150 and a hardware resource 170, for example. The software group 200 includes the application layer to be activated on an OS such as the UNIX® and a platform. For the hardware resource 170, a hardware resource (the ASIC 105 that exchanges data with the engine 150 and the like) other than the engine 150 illustrated in FIG. 2 is assumed.

The application layer includes programs, such as a PRINT (printer application) 201, a COPY (copy application) 202, a FAX (facsimile application) 203, a SCAN (scanner application) 204, a NETFILE (file accumulation application) 205, and a digital watermark application 206, which perform user-service-specific processes involved in an image formation.

The platform includes the control service layer that interprets a request for processing from the application layer to generate a request for obtaining the hardware resource 170, a system resource manager (SRM) 210 that performs a management of at least one hardware resource 170 and mediates obtainment requests from the control service layer, and the handler layer that manages the hardware resource 170 depending on the obtainment request from the SRM 210. The platform is configured to include an API 225 that enables receiving a processing request from the application layer by a predefined function. The OS executes software of the application layer and software of the platform in parallel.

The control service layer is configured to include at least one service module such as a Network Control Service (NCS) 211, an Operation panel Control Service (OCS) 212, a Facsimile Control Service (FCS) 213, a Memory Control Service (MCS) 214, an Engine Control Service (ECS) 215, a Delivery Control Service (DCS) 216, a Certification and charge Control Service (CCS) 217, a Log Control Service (LCS) 218, a User information Control Service (UCS) 219, and a System Control Service (SCS) 220.

A process of the NCS 211, which provides an application requiring a network I/O with a service available in common, distributes data received by each protocol from the side of the network to each application and performs mediation in transmitting data from each application to the side of the network. A process of the OCS 212 controls the operation panel 110. A process of the FCS 213 provides an API that allows performing a facsimile transmission/reception by using a PSTN or an ISDN network from the application layer, a registration/quotation of facsimile data of various kinds managed in a backup memory, a facsimile scanning, a facsimile reception/printing, and the like.

A process of the MCS 214 performs a memory control such as obtaining and freeing the system memory 102 and using the HDD 103. A process of the ECS 215 performs a control of the engine unit including the engine 150 and the hardware resource 170. A process of the DCS 216 controls a distribution of an accumulated document and the like. A process of the CCS 217 performs a control regarding an authentication and charging. A process of the LCS 218 manages and retains log information. A process of the UCS 219 manages user information. A process of the SCS 220 performs a processing such as an application management, an operation unit control, a system screen display, an LED display, a hardware resource management, and an interrupt application control.

A process of the SRM 210 controls the system and manages the hardware resource 170 with the SCS 220. For example, a process of the SRM 210 performs mediation in accordance with the obtainment request from an upper layer using a plotter included in the engine 150 and the hardware resource 170 and controls execution. Specifically, the process of the SRM 210 determines whether or not the hardware resource 170 to which the obtainment request is made is available (whether or not the hardware resource 170 is used by other obtainment request) and notifies, when available, the upper layer that the hardware resource 170 to which the obtainment request is made is available. The process of the SRM 210 performs a scheduling to use the hardware resource 170 with respect to the obtainment request from the upper layer and directly performs the requested content (a paper conveyance and an operation for image formation by a printer engine, a memory securement, a file generation, and the like, for example).

The handler layer includes a Facsimile Control Unit Handler (FCUH) 231 that manages the FCU 120 included in the hardware resource 170, an Image Memory Handler (IMH) 232 that allots a memory to a process and manages the memory allotted to the process, and a Media Edit Utility (MEU) 233 that controls the MLB 140 included in the hardware resource 170. The SRM 210 and the FCUH 231 uses an engine I/F 235 that enables transmitting a processing request to the hardware resource 170 by a predefined function to perform the processing request with respect to the hardware resource 170.

Functional Configuration

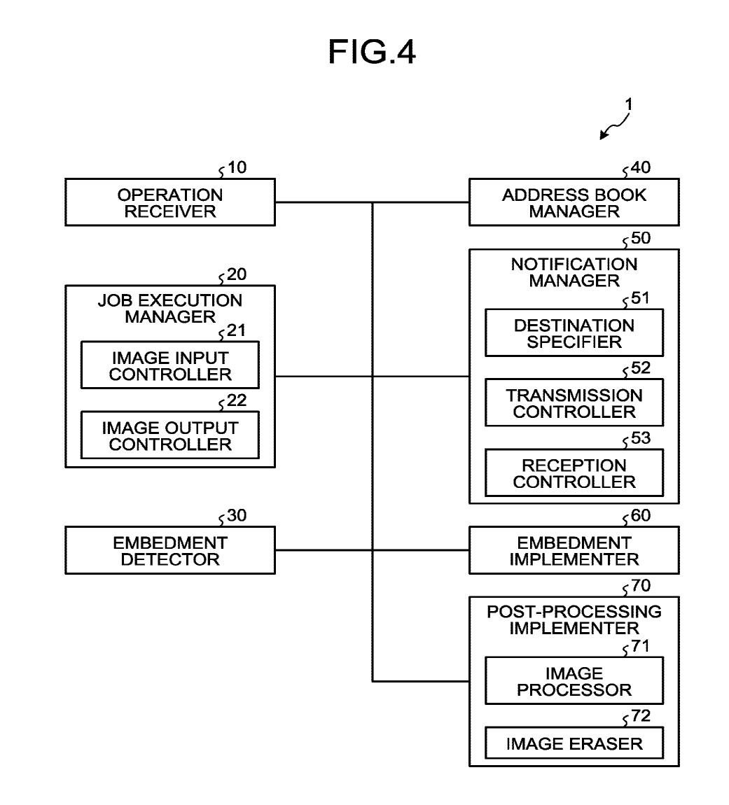

FIG. 4 is a block diagram of an example of a functional configuration of the multifunction peripheral 1 according to the embodiment. The multifunction peripheral 1 is provided, as functional constituents realized in cooperation with the hardware and the software (program) explained above, an operation receiver 10, a job execution manager 20, an embedment detector 30 (one mode of “detection unit”), an address book manager 40, a notification manager 50, an embedment implementer 60 (one mode of “embedment unit”), and a post-processing implementer 70 as illustrated in FIG. 4, for example.

The operation receiver 10 receives a job execution instruction by the operator using the operation panel 110 and passes information of the job whose execution is instructed to the job execution manager 20. The operation receiver 10 is realized in cooperation with the operation panel 110 and the controller 100 illustrated in FIG. 2, and software (the OCS 212 and the like illustrated in FIG. 3, for example) to be executed by the CPU 101 of the controller 100, for example.

The job execution manager 20 manages the execution of jobs such as the printing, the copying, the scan transmission, and the scan accumulation whose execution is instructed by the operator. The job execution manger 20 is provided with an image input controller 21 and an image output controller 22 (one mode of “output control unit”) as submodules.

The image input controller 21 controls an input of image data related to a job whose execution is instructed. For example, when the job whose execution is instructed includes a scanning of an image by a scanner engine (the engine 150 in FIGS. 2 and 3), the image input controller 21 controls the scanning of image data by the scanner engine.

The image output controller 22 controls an output of image data related to a job whose execution is instructed. For example, when the job whose execution is instructed is printing or copying, the image output controller 22 controls an output by printing of image data by a plotter engine (the engine 150 in FIGS. 2 and 3). Besides, when the job whose execution is instructed is the scan transmission, the image output controller 22 controls an operation of transmitting image data from the PHY 104 to an external terminal via the network, for example. Besides, when the job whose execution is instructed is the scan distribution, the image output controller 22 controls an operation of storing image data in the HDD 103 and the like, for example.

Here, especially in the multifunction peripheral 1 according to the embodiment, a request for determining whether or not to permit an output of image data is made to an authorizer who is different from the operator who has given the instruction for executing the job before the image data related to the job whose execution is instructed is output. The image output controller 22 then performs a control of outputting the image data only when the authorizer permits the output of the image data.

The job execution manager 20 is realized in cooperation with the controller 100 illustrated in FIG. 2 and the software (the PRINT 201, the COPY 202, the SCAN 204, the NETFILE 205, the NCS 211, the ECS 215, and the like illustrated in FIG. 3, for example) to be executed by the CPU 101 of the controller 100, for example.

The embedment detector 30 detects the embedment information which is embedded, as a digital watermark, onto the image data related to the job whose execution is instructed, i.e., the image data input by the control of the image input controller 21. Since the method of detecting the embedment information embedded, as a digital watermark, onto the image data is not specifically limited and known techniques can be used as they are, a detailed explanation thereof will be omitted here. The embedment detector 30 is realized in cooperation with the controller 100 illustrated in FIG. 2 and the software (the digital watermark application 206 and the like illustrated in FIG. 3, for example) to be executed by the CPU 101 of the controller 100, for example.

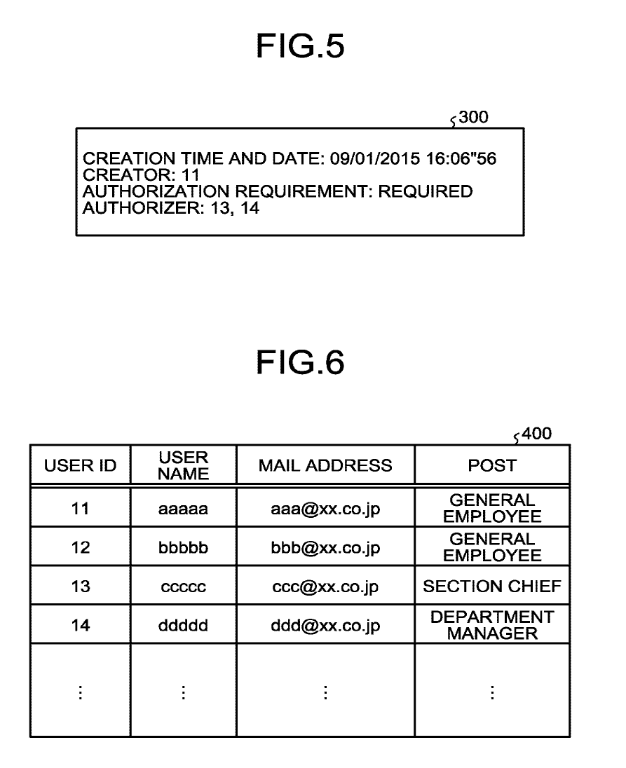

FIG. 5 illustrates an example of embedment information 300 embedded onto image data. In the embodiment, the embedment information 300 including a creation time and date when image data is created, a user ID of a creator who creates the image data, an authorization requirement indicating whether or not the authorization by the authorizer is required for the output of the image data, and a user ID of the authorizer is embedded onto the image data as illustrated in FIG. 5, for example. When there are a plurality of authorizers, a plurality of user IDs of the authorizers are included in the embedment information 300. Here, the embedment information 300 illustrated in FIG. 5 is just an example and the present invention is not limited to this example. It is only necessary that the embedment information 300 includes information that allows specifying a destination of the authorizer with reference to an address book to be explained later, and the embedment information 300 may be configured to include information indicating a post of the authorizer (“department manager”, “section chief”, and the like, for example) instead of the user ID of the authorizer, for example.

The address book manager 40 manages an address book (one mode of “destination management information”) of users registered as persons who use the multifunction peripheral 1. The address book manager 40 is realized in cooperation with the controller 100 illustrated in FIG. 2 and the software (the UCS 219 and the like illustrated in FIG. 3, for example) to be executed by the CPU 101 of the controller 100, for example.

FIG. 6 illustrates an example of an address book 400 managed by the address book manager 40. In the address book 400 managed by the address book manager 40, information including a user name, a mail address, a post, and the like of each user registered as a person who uses the multifunction peripheral 1 is stored by being associated with a unique user ID which is individually allotted to the user, as illustrated in FIG. 6, for example. This information is stored in the address book 400 in registering each user. The mail address is an electronic mail address used in transmission and reception, by the terminal device used by the user, of an electronic mail, for example. Here, the address book 400 illustrated in FIG. 6 is just an example and the present invention is not limited to this example. It is only necessary that the address book 400 is configured to include at least information indicating a correspondence relation between the embedment information 300 detected from the image data and the destination of the determination request.

The notification manager 50 manages an execution of notification to an external terminal device of the multifunction peripheral 1. As an example of the execution of the notification to the external terminal device, a transmission of the determination request by addressing to the terminal device of the authorizer and a reception of a response to the determination request are included. The notification manager 50 is provided with, as submodules, a destination specifier 51 (one mode of “destination specification unit”), a transmission controller 52 (one mode of “request transmission unit”), and a reception controller 53 (one mode of “response reception unit”).

The destination specifier 51 specifies a destination to which the determination request on whether or not to permit the output of the image data related to the job whose execution is instructed is transmitted based on the embedment information 300 detected from the image data by the embedment detector 30. Specifically, the destination specifier 51 is capable of referring to the address book 400 managed by the address book manager 40 and specifying, as the destination to which the determination request is transmitted, a mail address corresponding to a user ID (or a post), as a destination of authorization, included in the embedment information 300 detected from the image data. For example, when the embedment information 300 illustrated in FIG. 5 is detected by the embedment detector 30, the destination specifier 51 refers to the address book 400 illustrated in FIG. 6 and specifies, each as the destination of the transmission of the determination request, a mail address “ccc@xx.co.jp” corresponding to a user ID “13” and a mail address “ddd@xx.co.jp” corresponding to a user ID “14”.

The transmission controller 52 transmits, to the destination specified by the destination specifier 51, the determination request on whether or not to permit the output of the image data related to the job whose execution is instructed together with the image data related to the job whose execution is instructed. For example, when the mail address “ccc@xx.co.jp” corresponding to the user ID “13” and the mail address “ddd@xx.co.jp” corresponding to the user ID “14” are specified as destinations by the destination specifier 51, the transmission controller 52 transmits the determination request with the image data to those mail addresses each as the destination. Specifically, the transmission controller 52 transmits an electronic mail whose text is a message indicating the determination request and to which the image data is attached as an attached file to those mail addresses specified by the destination specifier 51, for example.

The reception controller 53 receives, from the terminal device of the authorizer, a response to the determination request transmitted by the transmission controller 52 (response indicating permission of the output of the image data or a response indicating no permission of the output of the image data). For example, when the transmission controller 52 transmits the determination request to the mail addresses “ccc@xx.co.jp” corresponding to the user ID “13” and “ddd@xx.co.jp” corresponding to the user ID “14” each as the destination, the reception controller 53 receives respective responses to the determination requests from the respective terminal devices specified by those mail addresses (a terminal device of an authorizer of the user ID “13” whose user name is “ccccc” and whose post is “section chief” and a terminal device of an authorizer of the user ID “14” whose user name is “ddddd” and whose post is “department manager”.

The response to the determination request received by the reception controller 53 is passed to the job execution manager 20 and used for determination, by the image output controller 22 of the job execution manager 20, on whether or not to output the image data (whether to continue or stop the job whose execution is instructed). In other words, when the response received by the reception controller 53 indicates permission of the output of the image data (YES), the image output controller 22 performs a control of continuing the job whose execution is instructed by the operator and outputting the image data. On the other hand, when the response received by the reception controller 53 indicates no permission of the output of the image data (NO), the image output controller 22 stops the job whose execution is instructed by the operator without outputting the image data.

Here, when the reception controller 53 receives a plurality of responses, the image output controller 22 determines whether or not to output the image data based on the plurality of responses. When the reception controller 53 receives the respective responses from the terminal device of the authorizer of the user ID “13” and the terminal device of the authorizer of the user ID “14” in the above example, the image output controller 22 performs a control of continuing the job whose execution is instructed by the operator and outputting the image data when both responses indicate permission of the output of the image data.

When the reception controller 53 does not receive a response even after an elapse of a predetermined period of time from the transmission, by the transmission controller 52, of the determination request, the image output controller 22 stops the job whose execution is instructed by the operator without outputting the image data (time-out processing), similarly to the case where the response indicating no permission of the output of the image data is received. When the reception controller 53 does not receive a response even after an elapse of a predetermined period of time from the transmission, by the transmission controller 52, of the determination request, the transmission controller 52 may be configured to transmit the determination request again (retry) to the destination specified by the destination specifier 51.

The notification manager 50 is realized in cooperation with the controller 100 illustrated in FIG. 2 and the software (the NCS 211 and the like illustrated in FIG. 3) to be executed by the CPU 101 of the controller 100.

When the response received by the reception controller 53 indicates permission of the output of the image data, the embedment implementer 60 embeds, as a digital watermark onto the image data to be output, information related to the response. Here, the information related to the response is, for example, a user ID of the authorizer who has permitted the output of the image data, a log ID that allows, when the permission of the output of the image data is recorded and managed as a log, identifying the log, and the like. Besides, not limiting to the information related to the response, the embedment implementer 60 may embed, as a digital watermark onto the image data to be output, a log ID that allows identifying a debug log which is recorded and managed depending on the output of image data, for example.

Since the method of embedding information of various kinds onto image data as a digital watermark is not limited specifically and known techniques can be used as they are, a detailed explanation thereof will be omitted here. The embedment implementer 60 is realized in cooperation with the controller 100 illustrated in FIG. 2 and the software (the digital watermark application 206 and the like illustrated in FIG. 3, for example) to be executed by the CPU 101 of the controller 100, for example.

The post-processing implementer 70 performs a post-processing on the image data related to the job whose execution is instructed depending on the response received by the reception controller 53. The post-processing implementer 70 is provided with, as submodules, an image processor 71 (one mode of “image processing unit”) and an image eraser 72 (one mode of “data erasing unit”).

The image processor 71 adds a stamp image and the like indicating that the output is permitted to the image data to be output when the response received by the reception controller 53 indicates permission of the output of the image data and the image output controller 22 continues the job whose execution is instructed by the operator. This stamp image is not information which is invisible to human eyes like the digital watermark but information which is visible to human eyes. The stamp image is added at a predetermined given position like an upper right of the output image data, for example. The addition of the stamp image is just one example of the post-processing and post-processing different from the addition of the stamp image may be performed.

When the response received by the reception controller 53 is no permission of the output of the image data and the image output controller 22 stops the job whose execution is instructed by the operator, the image eraser 72 erases the image data related to the job, i.e., the image data input depending on the control of the image input controller 21 from the inside of the multifunction peripheral 1. Specifically, the image eraser 72 erases the image data temporarily retained in the system memory 102 of the controller 100 in FIG. 2 and the image data stored in the HDD 103.

The post-processing implementer 70 is realized in cooperation with the controller 100 illustrated in FIG. 2 and the software (the MCS 214 and the like illustrated in FIG. 3, for example) to be executed by the CPU 101 of the controller 100, for example.

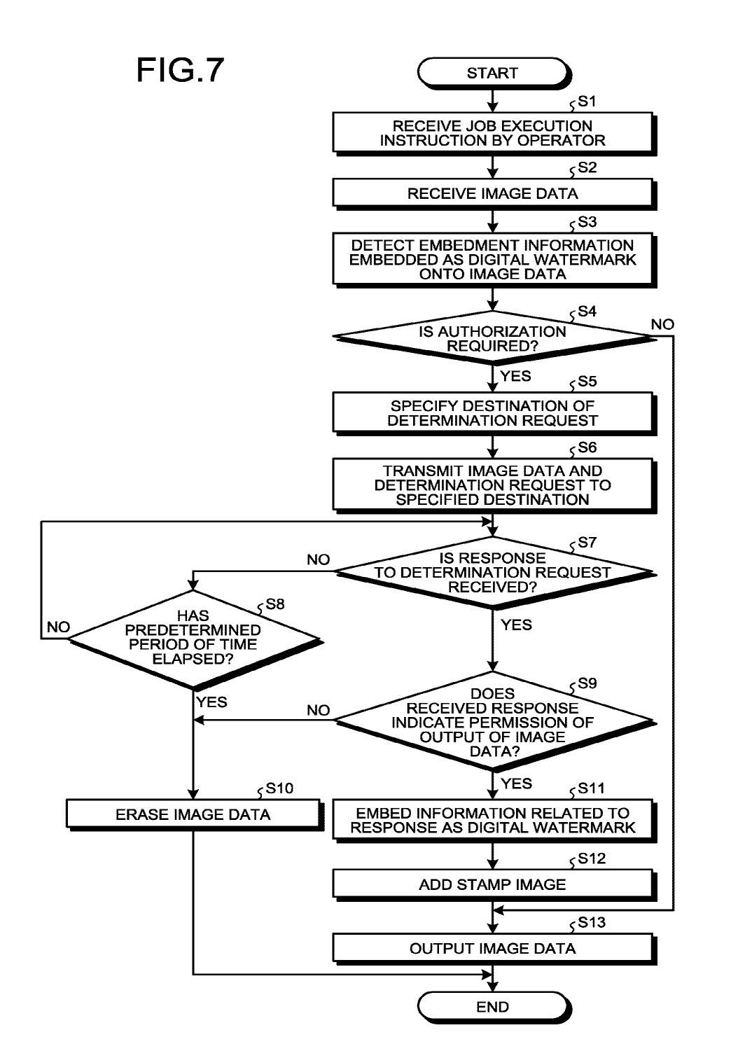

Explanation of Operation Next, the operation of the multifunction peripheral 1 according to the embodiment will be explained. First, a summary of the operation of the multifunction peripheral 1 according to the embodiment will be explained with reference to FIG. 7. FIG. 7 is a flowchart of an example of an operation procedure of the multifunction peripheral 1 according to the embodiment.

First, the operation receiver 10 receives a job execution instruction by the operator (step S1).

Next, the image data related to the job whose execution is instructed by the operator is input (received) under the control of the image input controller 21 of the job execution manager 20 (step S2).

Next, the embedment detector 30 detects the embedment information which is embedded, as a digital watermark, onto the image data input at step S2 (step S3).

Next, the image output controller 22 of the job execution manager 20 determines whether or not to require the authorization by the authorizer with respect to the output of the image data input at step S2 based on the embedment information detected at step S3 (step S4). Here, when it is determined that the authorization by the authorizer is not required (“No” at step S4), the processing moves to step S13 to be explained later.

On the other hand, when it is determined that the authorization by the authorizer is required with respect to the output of the image data (“Yes” at step S4), the destination specifier 51 of the notification manager 50 specifies a destination to which the determination request on whether or not to permit the output of the image data is transmitted based on the embedment information detected at step S3 (step S5).

Next, the transmission controller 52 of the notification manager 50 transmits the image data input at step S2 and the determination request on whether or not to permit the output of the image data to the destination specified at step S5 (step S6).

The image output controller 22 of the job execution manager 20 then determines whether or not the reception controller 53 of the notification manager 50 has received a response to the determination request transmitted at step S6 (step S7) and further determines whether or not a predetermined period of time has elapsed after the transmission of the determination request at step S6 (step S8). When the predetermined period of time has not elapsed after the transmission of the determination request at step S6 (“No” at step S8), the determinations at steps S7 and S8 are repeated.

Here, when the reception controller 53 receives a response before the elapse of the predetermined period of time (“Yes” at step S7), the image output controller 22 determines whether or not the response received by the reception controller 22 indicates permission of the output of the image data (step S9). When the response received by the reception controller 53 indicates no permission of the output of the image data (“No” at step S9), the image output controller 22 stops the job whose execution is instructed by the operator and the image eraser 72 of the post-processing implementer 70 erases the image data input at step S2 (step S10).

On the other hand, when the response received by the reception controller 53 indicates permission of the output of the image data (“Yes” at step S9), the embedment implementer 60 embeds information related to the received response onto the image data input at step S2 as a digital watermark (step S11). Moreover, the image processor 71 of the post-processing implementer 70 adds the stamp image indicating that the output is permitted to the image data input at step S2, as one example of the post-processing (step S12). The processing at steps S11 and S12 is not essential and it is only necessary that the processing is performed when the execution thereof is designated.

After that, the image output controller 22 of the job execution manager 20 causes the image data to be output in accordance with the job whose execution is instructed (step S13) and a series of operation of the multifunction peripheral 1 ends.

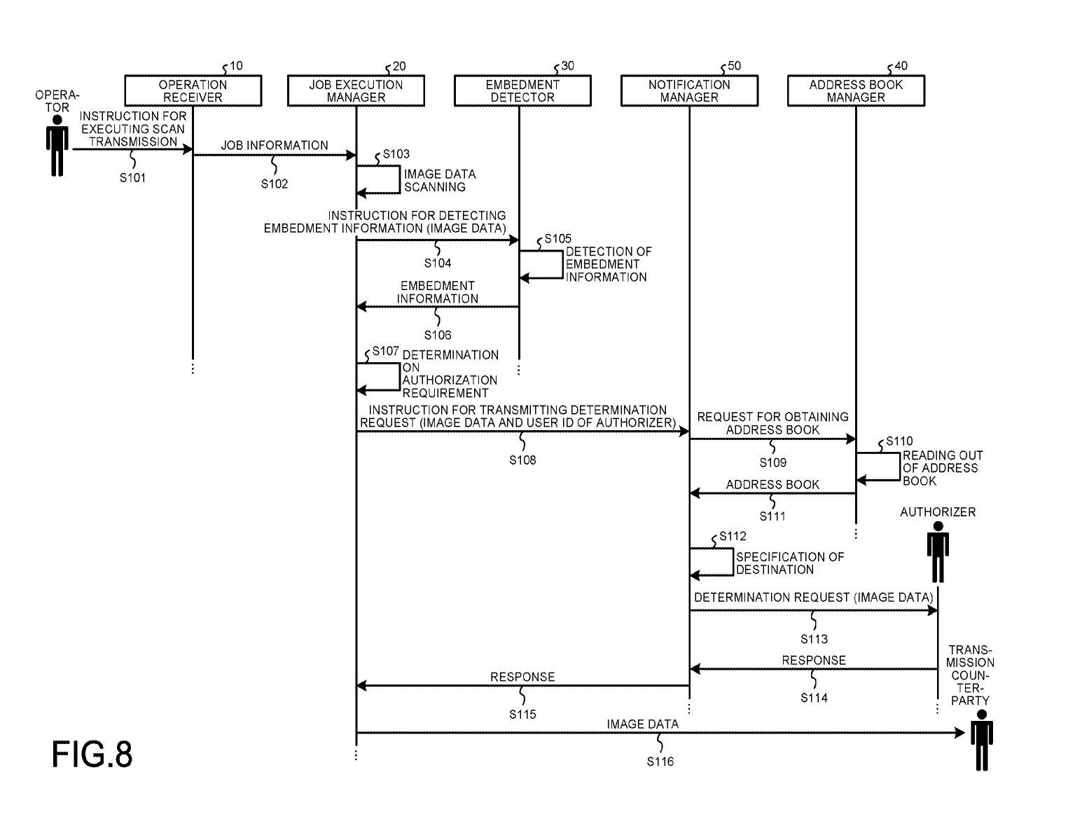

Next, an example of an operation of the multifunction peripheral 1 in a case where the job whose execution is instructed by the operator is the scan transmission will be explained with reference to FIG. 8. FIG. 8 is a sequence diagram explaining an example of an operation of the multifunction peripheral 1 when an instruction for executing the scan transmission is given by the operator, and illustrates an example of a situation where the response to the determination request indicates permission of the output of the image data.

When the operator instructs the multifunction peripheral 1 to execute the scan transmission (step S101), the instruction for executing the scan transmission by the operator is received by the operation receiver 10. Then, job information including conditions for scanning image data and information of transmission destination of the image data is passed from the operation receiver 10 to the job execution manager 20 (step S102).

Next, the job execution manager 20 controls the scanner engine based on the job information received from the operation receiver 10 to scan the image data related to the job (step S103). The job execution manager 20 passes the image data scanned at step S103 to the embedment detector 30 and instructs the embedment detector 30 to detect the embedment information (step S104).

Next, the embedment detector 30 detects the embedment information which is embedded as a digital watermark onto the image data received from the job execution manager 20 in accordance with the instruction from the job execution manager 20 (step S105). The embedment detector 30 then returns the embedment information detected from the image data to the job execution manager 20 (step S106).

Next, the job execution manager 20 determines whether or not to require the authorization by the authorizer with respect to the output of the image data based on the embedment information detected by the embedment detector 30 from the image data (step S107). Here, information to the effect that the authorization by the authorizer is required for the output of the image data and the user ID of the authorizer are assumed to be included in the embedment information. The job execution manager 20 determines that the authorization by the authorizer is required for the output of the image data based on the embedment information, passes the image data and the user ID of the authorizer to the notification manager 50, and instructs the notification manager 50 to transmit the determination request (step S108).

Next, the notification manager 50 first requests the address book manager 40 to obtain the address book in accordance with the instruction from the job execution manager 20 (step S109). The address book manager 40 reads out the address book in response to the request by the notification manager 50 (step S110) and passes the address book to the notification manager 50 (step S111).

Next, the notification manager 50 refers to the address book received from the address book manager 40 and specifies a mail address corresponding to the user ID of the authorizer received from the job execution manager 20 as a destination to which the determination request is transmitted (step S112). The notification manager 50 transmits the image data received from the job execution manager 20 and the determination request on whether or not to permit the output of the image data to the mail address specified at step S112 (mail address of the terminal device of the authorizer) as the destination (step S113). On this occasion, the notification manager 50 transmits the image data and the determination request on whether or not to permit the output the image data to respective mail addresses each as a destination when a plurality of mail addresses are specified as destinations to which the determination request is transmitted.

After that, when receiving a response to the determination request transmitted at step S113 from the terminal device of the authorizer (step S114), the notification manager 50 passes the response to the determination request to the job execution manager 20 (step S115). Here, the response to the determination request is assumed to indicate permission of the output of the image data.

When receiving the response from the notification manager 50, the job execution manager 20 continues the scan transmission job and transmits the image data scanned at step S103 to a transmission destination (terminal device of a transmission counterparty) included in the job information received at step S102 from the operation receiver 10 (step S116). Here, when the response to the determination request indicates no permission of the output of the image data, the scan transmission job is stopped and the image data is erased by the post-processing implementer 70.

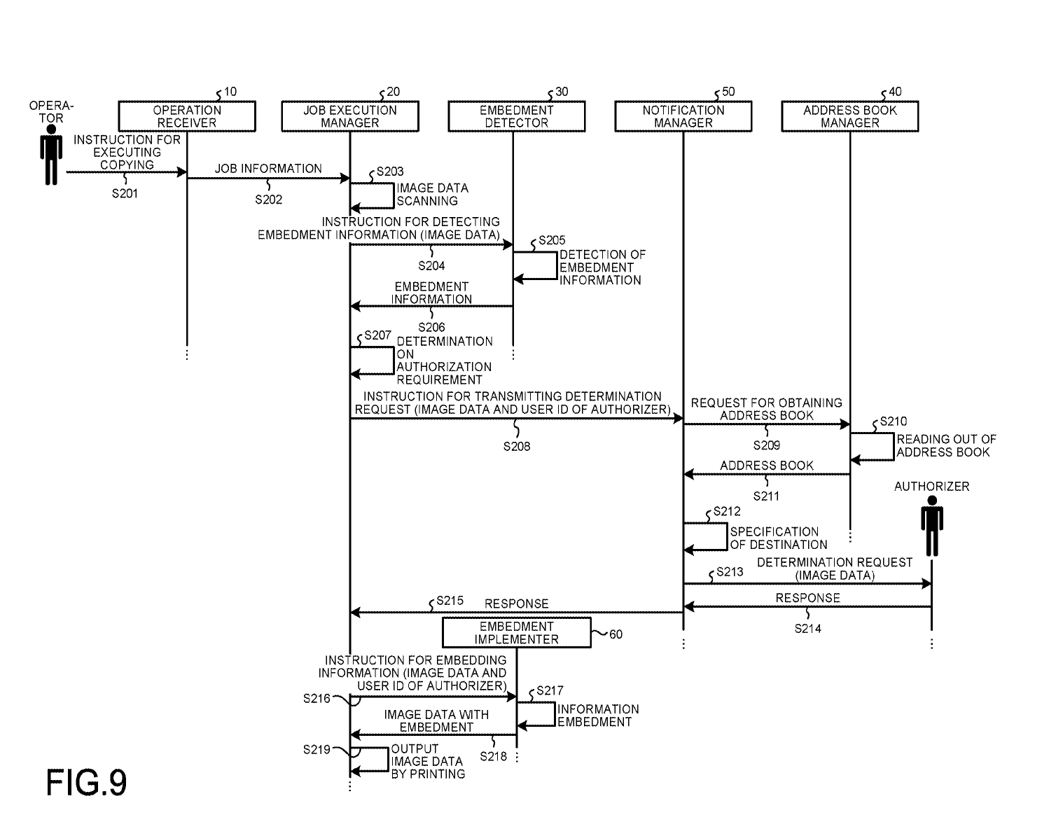

Next, an example of an operation of the multifunction peripheral 1 in a case where the job whose execution is instructed by the operator is the copying (duplication) will be explained with reference to FIG. 9. FIG. 9 is a sequence diagram explaining an example of an operation of the multifunction peripheral 1 when an instruction for executing copying is given by the operator, and illustrates an example of a situation where the response to the determination request indicates permission of the output of the image data.

When the operator instructs the multifunction peripheral 1 to execute the copying (step S201), the instruction for executing the copying by the operator is received by the operation receiver 10. Then, job information including conditions for scanning image data and information of print settings is passed from the operation receiver 10 to the job execution manager 20 (step S202).

Next, the job execution manager 20 controls the scanner engine based on the job information received from the operation receiver 10 to scan the image data related to the job (step S203). The processing from step S203 to step S215 is the same as the processing from step S103 to step S115 in FIG. 8 and the explanation will be omitted here.

In this example, when receiving the response (response to the effect of permitting the output of the image data) to the determination request form the notification manager 50 at step S215, the job execution manager 20 continues the copy job, passes the image data scanned at step S203 and the user ID of the authorizer who has permitted the output of the image data (the user ID of the authorizer included in the embedment information received from the embedment detector 30 at step S206) to the embedment implementer 60, and instructs the embedment implementer 60 to embed the information (step S216).

Next, the embedment implementer 60 embeds, as a digital watermark, the user ID of the authorizer who has permitted the output of the image data onto the image data received from the job execution manager 20 in accordance with the instruction from the job execution manager 20 (step S217). The embedment implementer 60 then returns the image data onto which the user ID of the authorizer is embedded as a digital watermark to the job execution manager 20 (step S218).

When receiving the image data onto which the embedment is done from the embedment implementer 60, the job execution manager 20 controls the plotter engine based on the job information received from the operation receiver 10 at step S202 to output, by printing, the image data onto which the user ID of the authorizer who has permitted the output of the image data is embedded as a digital watermark (step S219). Here, when the response to the determination request is no permission of the output of the image data, the copy job is stopped and the image data is erased by the post-processing implementer 70.

While the embedment implementer 60 is configured to embed the user ID of the authorizer who has permitted the output of the image data as a digital watermark onto the image data to be output by printing in this example, a log ID of a log indicating that the output of the image data is permitted, a log ID of a debug log which is recorded and managed depending on the output of the image data, and the like may be embedded as a digital watermark onto the image data. While this example exemplifies a case where the instruction for executing the copying (duplication) is given by the operator, the image data onto which the same information as this example is embedded as a digital watermark may be output when the output of the image data is permitted by the authorizer in the case where an instruction for executing other jobs, such as the scan transmission and the scan accumulation, involving the output of the image data is given by the operator.

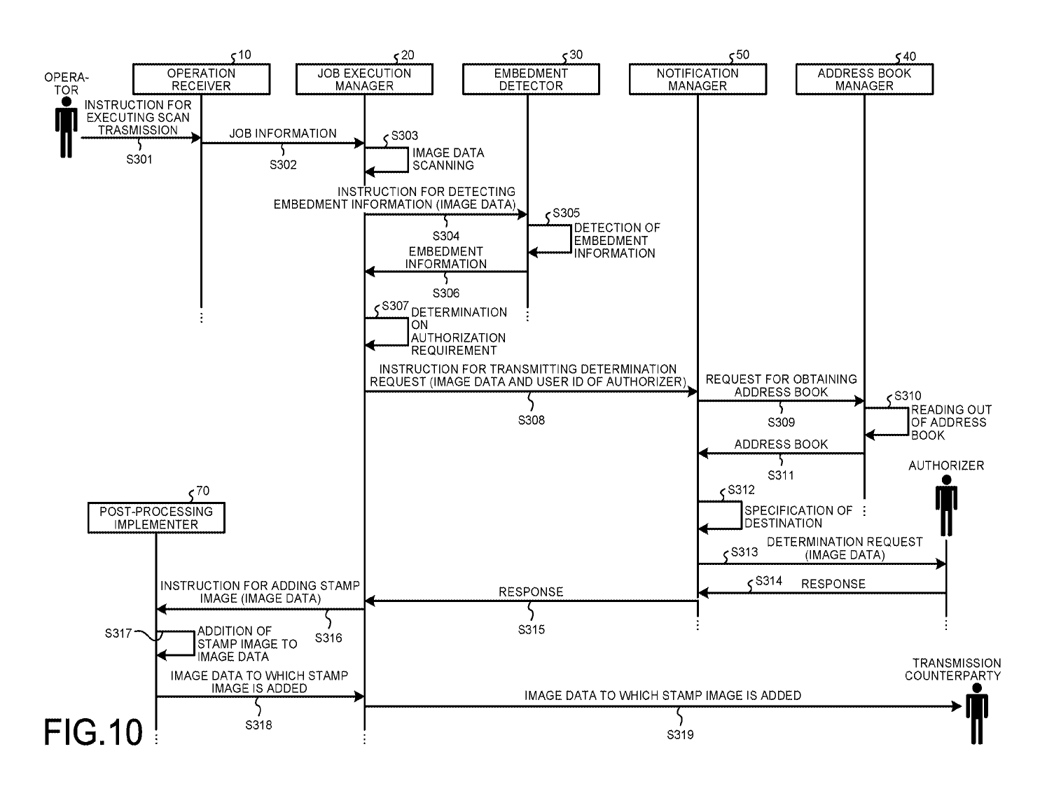

Next, an example of an operation of the multifunction peripheral 1 that outputs the image data to which the stamp image indicating that the output is permitted is added when the output of the image data is permitted by the authorizer will be explained with reference to FIG. 10. FIG. 10 is a sequence diagram explaining an example of an operation of the multifunction peripheral 1 that outputs the image data to which the stamp image is added and illustrates an example of an operation when an instruction for executing the scan transmission is given by the operator similarly to the example in FIG. 8. The processing from step S301 to step S315 in FIG. 10 is the same as the processing from step S101 to step S115 in FIG. 8 and the explanation will be omitted here.

In this example, when receiving the response (response to the effect that the output of the image data is permitted) to the determination request from the notification manager 50 at step S315, the job execution manager 20 continues the scan transmission job, passes the image data scanned at step S303 to the post-processing implementer 70, and instructs the post-processing implementer 70 to add the stamp image (step S316).

Next, the post-processing implementer 70 adds the stamp image indicating that the output is permitted to the image data received from the job execution manager 20 in accordance with the instruction from the job execution manager 20 (step S317). The post-processing implementer 70 then returns the image data to which the stamp image is added to the job execution manager 20 (step S318).

When receiving the image data to which the stamp image is added from the post-processing implementer 70, the job execution manager 20 transmits the image data to which the stamp image is added to a transmission destination (terminal device of a transmission counterparty) included in the job information received from the operation receiver 10 at step S302 (step S319). When the response to the determination request indicates no permission of the output of the image data, the scan transmission job is stopped and the image data is erased by the post-processing implementer 70.

While this example exemplifies the case where the instruction for executing the scan transmission is given by the operator, the image data onto which the stamp image is added may be output similarly to this example when the output of the image data is permitted by the authorizer in the case where the instruction for executing other jobs, such as the copying and the scan accumulation, involving the output of the image data is given by the operator. Besides, information such as the user ID of the authorizer may be embedded as a digital watermark and the image data to which the stamp image indicating that the output is permitted is added may be output when the output of the image data is permitted by the authorizer in combination with the example of FIG. 9 and the example of FIG. 10.

As explained in detail so far by listing specific examples, the embedment information is detected from the image data related to the job whose execution is instructed by the operator and the destination to which the determination request on whether or not to permit the output of the image data is transmitted is specified based on the embedment information in the multifunction peripheral 1 according to the embodiment. Then, the determination request is transmitted with the image data to the specified destination and whether or not to output the image data is determined based on the response to the determination request. It is therefore possible according to the multifunction peripheral 1 to output only image data whose output is permitted by the authorizer whose is a user different from the operator who gives the instruction for outputting the image data.

Besides, by embedding information related to the response, such as the user ID of the authorizer, onto the image data and outputting the image data when the response to the determination request indicates permission of the output of the image data, it becomes possible in the multifunction peripheral 1 according to the embodiment to determine who has permitted the output of the image data based on the image data output.

When a plurality of destinations are specified based on the embedment information detected from the image data, by transmitting the determination request with the image data to the plurality of destinations and determining whether or not to output the image data based on a plurality of responses for the respective determination requests, it becomes possible in the multifunction peripheral 1 according to the embodiment to deal with a workflow requiring authorizations by a plurality of authorizers.

Moreover, by referring to the address book indicating the correspondence relation between the embedment information embedded onto the image data and the destination and specifying the destination of the determination request, it become possible in the multifunction peripheral 1 according to the embodiment to easily and appropriately specify the destination of the determination request. For example, when a post and a mail address are associated and stored for each user in the address book, it is possible with a configuration in which embedment information indicating the post of the authorizer is embedded onto the image data to specify the destination of the determination request.

By determining not to output the image data (stopping the job whose execution is instructed) when the response to the determination request is not received even after an elapse of a predetermined period of time from the transmission of the determination request, it is possible in the multifunction peripheral 1 according to the embodiment to prevent the job which is in the middle of processing from remaining.

By transmitting the determination request to the specified destination again when the response to the determination request is not received even after an elapse of a predetermined period of time from the transmission of the determination request, it is possible in the multifunction peripheral 1 according to the embodiment to encourage the authorizer to make a response to the determination request.

By embedding information such as a log ID that allows identifying a debug log recorded depending on the output of the image data onto the image data and outputting the image data when the response to the determination request indicates permission of the output of the image data, it is possible in the multifunction peripheral 1 according to the embodiment to subsequently trace the background and the like of the output of the image data.

Moreover, by erasing image data when the response to the determination request indicates no permission of the output of the image data, it is possible in the multifunction peripheral 1 according to the embodiment to effectively prevent the image data remaining in the multifunction peripheral 1 from being illegally leaked.

Furthermore, by adding the stamp image indicating that the output is permitted to the image data and outputting the image data when the response to the determination request indicates permission of the output of the image data, it is possible in the multifunction peripheral 1 according to the embodiment to make the output image data clearly recognized as the image whose output is permitted.

Supplemental Explanation

The functional constituents of the multifunction peripheral 1 according to the embodiment can be realized in cooperation with the hardware configured as a computer system like the controller 100 illustrated in FIG. 2 as one example and the program (software) to be executed by using the hardware. In this case, the program that realizes the functional constituents of the multifunction peripheral 1 can be provided by being stored in advance in the HDD 103 in the inside of the controller 100, for example. Besides, the program may be provided by being recorded in a file of an installable format or of an executable format in a computer-readable recording medium such as a CD-ROM, a flexible disk (FD), a CD-R, and a DVD (Digital Versatile Disc). The program may be provided by being stored on another computer connected to a network and downloaded to the multifunction peripheral 1 via the network. The program may be provided or distributed via the network.

The program to be executed in the multifunction peripheral 1 according to the embodiment has a module configuration including program components respectively corresponding to the functional constituents of the multifunction peripheral 1, i.e., the operation receiver 10, the job execution manager 20 (the image input controller 21 and the image output controller 22), the embedment detector 30, the address book manager 40, the notification manager (the destination specifier 51, the transmission controller 52, and the reception controller 53), the embedment implementer 60, the post-processing implementer (the image processor 71 and the image eraser 72), for example. As an actual hardware, those functional constituents are configured to be loaded and generated on a main storage device such as the system memory 102 when the CPU 101 of the controller 100 reads out from the HDD 103 and executes the program. Besides, a part or all of the functional constituents of the multifunction peripheral 1 can be realized by using hardware such as the ASIC 105 of the controller 100, for example.

According to the embodiment, there is an advantage in that only image data whose output is permitted by a user different from a user who gives an instruction for outputting the image data can be output.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus comprising:
a detector configured to detect embedment information embedded onto image data;
a destination specifier configured to specify a destination to which a request for determination on whether to permit an output of the image data is transmitted based on the detected embedment information;
a request transmitter configured to transmit the request together with the image data to the destination;
a response receiver configured to receive a response to the request; and
an output controller configured to determine whether to output the image data based on the response.

2. The information processing apparatus according to claim 1, further comprising an embedder configured to embed information related to the response onto the image data when the response indicates permission of the output of the image data.

3. The information processing apparatus according to claim 1, wherein
the destination specifier specifies a plurality of destinations,
the request transmitter transmits the request together with the image data to the plurality of destinations,
the response receiver receives a plurality of responses corresponding to the determination requests transmitted to the plurality of destinations, and
the output controller determines whether to output the image data based on the plurality of responses.

4. The information processing apparatus according to claim 1, wherein the destination specifier refers to destination management information indicating a correspondence relation between the embedment information and the destination to specify the destination corresponding to the detected embedment information.

5. The information processing apparatus according to claim 1, wherein the output controller determines not to output the image data when the response receiver does not receive the response even after an elapse of a predetermined period of time from when the request transmitter transmits the request.

6. The information processing apparatus according to claim 1, wherein the request transmitter transmits the request again to the destination when the response receiver does not receive the response even after an elapse of a predetermined period of time from when the request transmitter transmits the request.

7. The information processing apparatus according to claim 1, further comprising an embedder configured to embed information that allows specifying a debug log to be recorded depending on the output of the image data onto the image data when the response indicates permission of the output of the image data.

8. The information processing apparatus according to claim 1, further comprising a data eraser configured to erase the image data when the response indicates no permission of the output of the image data.

9. The information processing apparatus according to claim 1, further comprising an image processor configured to add a stamp image indicating that the output is permitted to the image data when the response indicates permission of the output of the image data.

10. An image output control method executed by an information processing apparatus, comprising:
detecting embedment information embedded onto image data;
specifying a destination to which a request for determination on whether to permit an output of the image data is transmitted based on the detected embedment information;
transmitting the request together with the image data to the destination;
receiving a response to the request; and
determining whether to output the image data based on the response.

11. A non-transitory computer-readable recording medium with an executable program stored thereon, wherein the program instructs a computer to perform:
detecting embedment information embedded onto image data;
specifying a destination to which a request for determination on whether to permit an output of the image data is transmitted based on the detected embedment information;
transmitting the request together with the image data to the destination;
receiving a response to the request; and
determining whether to output the image data based on the response.
